(19) United States
(12) Patent Application Publication
(10) Pub. No.: US 2007/0043878 A1
(43) Pub. Date: Feb. 22, 2007

(54) Virtual robot communication format customized by endpoint

(75) Inventors: Matthew C. Carlson, Seattle, WA (US); Todd S. Biggs, Kirkland, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/207,664

(22) Filed: Aug. 18, 2005

(51) Int. Cl. G06F 15/16

(52) U.S. Cl. 709/246

(57) ABSTRACT

An interactive agent, or bot, is disclosed which is capable of formatting information for optimal presentation depending at least in part on the functionality of the endpoint device receiving the information. The bot may operate as part of an IM application interface which provides protocols for network communications between a user endpoint device and the bot.

### BACKGROUND

1. Field of the Present System

The present system is directed to methods for formatting information presented by a virtual robot based on endpoint device properties to optimize the presentation of the information on the endpoint device.

2. Description of the Related Art

Instant messaging (“IM”) is one of the most popular and still growing systems for users to communicate with one another in real time over a presence based network. Presence technology makes it possible to locate and identify a computing device, wherever it might be, when the device is connected to a network and available to receive and answer a communication in real time. Typically, IM communications are accomplished through the use of an IM client application installed on each user's computing device, which may be a computer, cellular telephone, personal digital assistant (“PDA”) or other networked device. Generally, each user creates an identification name and submits the name to an instant messaging system that stores the name in a database, and associates the user's presence with that ID. Users who are interested in chatting with a particular individual can add the identification name associated with that individual to their private list, typically referred to as a “buddy list.”

When any of the individuals listed on a user's buddy list are connected to IM, the instant messaging system sends an alert indicating that the individual is online and is available for chatting or a user is able to view their buddy's presence in a contact list. To initiate an IM conversation, an initiating user may simply select the identification name of a user to be contacted from the buddy list provided by the IM client application. The IM client application then sends a request to initiate an IM session to an IM client application remotely executing on the computing device of the user having the selected user ID. The remotely executing IM client application then provides some indication to the contacted user that the initiating user would like to engage in an IM conversation. If so inclined, the contacted user may then respond in kind.

As opposed to communications between two live users, another popular use of IM is to perform searching and other functions using an interactive agent software application program referred to as a virtual robot, or bot for short. The front end of the interactive agent is configured to allow a user to interact with the bot as if the bot were another live user on his/her buddy list—the bot can have an identification name in the buddy list and a user can initiate an IM session with his/her bot in the same manner as initiating a conversation with other users. Bots generally accept and respond using natural language, thus creating and fostering the illusion that the user is communicating with another live user. While the degree of sophistication of a bot may vary greatly, a bot may be configured to have a visual icon, or avatar, appearing to a user, and may also be configured to have human attributes and personality traits.

Some bots, generally referred to as chatterbots, attempt to simulate human conversation. Early well known chatterbot application programs include “Eliza” and “Parry,” both of which processed a received input and formulated a response attempting to emotionally and contextually emulate a human response. IM chatterbots may serve purely social functions, responding to or initiating natural language IM sessions with a user, and assuming programmed personality traits.

Instead of or in addition to social functions, other bots serve as a source of information for a user. The back end of such bots may be integrated or otherwise in communication with one or more data stores to access information thereon in response to requests by a live user. Enterprise service providers such as MSN®, Yahoo®, AOL®, or other online service providers are incorporating IM bots to provide a convenient way for users to get answers to any variety of questions and search for information relating to news, weather reports, driving directions, movie times, stock quotes, or any other information that may be available over a network such as the World Wide Web. An IM bot may be specialized to provide information from a single, dedicated database, while other IM bots are able to connect to a variety of outside databases and provide the user with a variety of information.

As the sophistication and mobility of electronic devices continue to grow, an ever increasing array of such devices are capable of supporting network communications such as IM. Currently, computers, gaming devices, mobile phones, PDAs and other hand-held devices all support IM over the Internet or other network connection. One area of technology which is struggling to keep pace with the growing number of network-connected devices is the effective formatting and presentation of information over each of a wide variety of computing devices. For example, while computers typically have monitors and browsers capable of displaying a rich array of text, images, links, etc., many portable and other network-connected devices do not.

### SUMMARY

Embodiments of the present system in general relate to an interactive agent, or bot, capable of formatting information depending at least in part on the functionality of the endpoint device receiving the information. The bot may operate as part of an IM application interface which provides protocols for network communications between a user endpoint device and the bot. The endpoint device may be a variety of network-enabled devices including a desktop computer, a laptop computer, a tablet computer, a hand-held computer, a gaming device, a mobile telephone and a personal digital assistant.

The bot may appear as any other contact in the user's stored contacts, and the user may initiate contact with the bot by selecting the bot from his or her stored contacts. Once contact is established, the bot may receive content and metadata from a software client running on the device. The bot may be configured with natural language capabilities and speech conversion and recognition capabilities so that communications with the bot may be carried on using natural language in text or by audio exchanges (within the IM client or within a VoIP client). Upon receipt of a content communication from a user, the bot determines what the content communication means and how best to reply to the user's communication. This reply may be in the nature of a purely social reply, or the reply may require searching of third party databases for information available over the World Wide Web.

Once the bot has content for a response to the user, the response content is formatted by the bot's endpoint formatting engine. When a user establishes contact with the bot, metadata is passed from the user device to the endpoint formatting engine. The metadata describes the functionality and characteristics of the user's device, the client running on the device and, in embodiments, may also describe personal preferences and information about the user. This metadata is used by the endpoint formatting engine to present the content sent back to the user device in a format that is optimized for the user's device.

Thus, for example, where the user's device is a desktop computer having an updated browser and keyboard, the bot may converse with the user in a full natural language discourse, possible also including graphics and video images. However, where the user's device is a hand-held mobile device, such as a mobile phone or pda, the bot may format the content sent to the user device in a menu driven or hyperlink driven format. A wide variety of other criteria may be used by the bot to format the content sent to the user device in a wide variety of other formats.

### BRIEF DESCRIPTION OF THE DRAWINGS

FIG. 1 is a software block diagram of a bot according to an embodiment of the present system.

FIG. 2 is a flowchart showing operation of the steps according to an embodiment of the present system.

FIG. 3 is a flowchart showing operation of the endpoint formatting engine to format content conveyed to a user device according to an embodiment of the present system.

FIG. 4 is an illustration of content presentation by a bot according to the present system over a display of a computer.

FIG. 5 is an illustration of content presentation by a bot according to an alternative embodiment of the present system over a display of a computer.

FIG. 6 is an illustration of content presentation by a bot according to the present system over a display of a mobile telephone.

FIG. 7 is an illustration of content presentation by a bot according to the present system over a display of a personal digital assistant.

FIG. 8 is a block diagram of computer hardware suitable for implementing embodiments of the present system.

### DETAILED DESCRIPTION

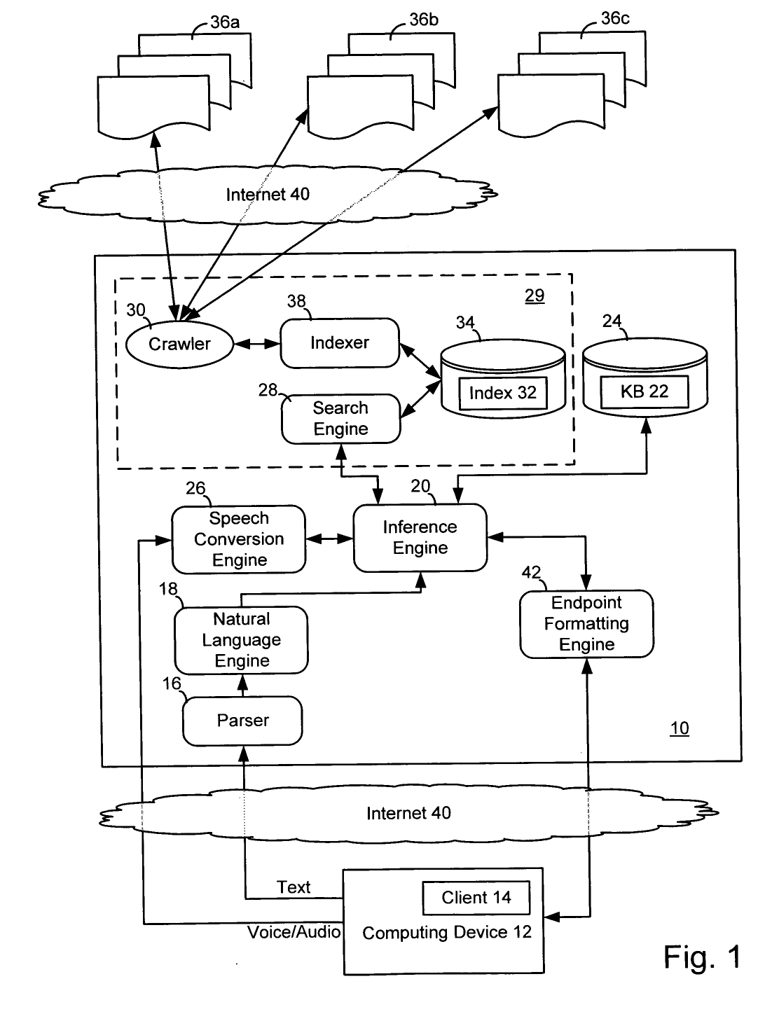

Embodiments of the present system will now be described with reference to FIGS. 1-8 which in general relate to an interactive agent, or bot, capable of formatting content to optimize the content presentation based on the endpoint device receiving the content. In general, the bot adaptively interacts with a user based on the endpoint. First, the bot determines the type of device that the user is using, along with other attributes of the device. Then, the bot creates the content for the interaction. Next, the bot may modify the communication style and formatting of the content to optimize the user experience for that device. For example, in one application, a bot may interact with a user using natural language parsing if the user is on a personal computer and capable of typing in long sentences. In another example, the bot would adjust to displaying a menu of options where a user is using a mobile telephone.

Referring now to FIG. 1, there is shown a bot 10, which, as explained in the Background section, may be an interactive agent capable of creating the impression of human interaction. Bot 10 may be implemented in software, hardware or a combination of software and hardware. When portions of bot 10 are implemented in software, bot 10 may be embodied in any number of computer languages, including Java or other object-oriented type programming languages. As explained hereinafter, in embodiments, bot 10 uses IM as the application interface for interacting with a user. However, it is to be understood that the present system is not limited to IM as an application interface and bot 10 may interact with a user via a variety of other application interfaces in alternative embodiments. As a further example, bot 10 may use a voice-over-IP (“VoIP”) client. Bot 10 may also receive audio via the MSN IM client.

Bot 10 may be implemented in an enterprise service provider, such as such as MSN®, Yahoo®, AOL®, or other online service providers. In embodiments, bot 10 may more specifically be part of an IM agent application program executing on an IM server, which may be of known configuration apart from bot 10. It is understood that one or more portions of bot 10 may instead be implemented in a client application program 14 executing on a user's computing device 12. In a further alternative embodiment, bot 10 may instead be implemented in whole or in part on a third party server accessible to the client.

In general, computing device 12 may be, but is not limited to, a desktop computer, a laptop computer, a tablet computer, a hand-held computer, a gaming device, such as the Xbox® gaming device by Microsoft Corporation of Redmond, Wash., a mobile telephone and a personal digital assistant. As indicated, device 12 may be connected to bot 10 via a distributed computing network, such as the Internet.

Client 14 may be an IM client, but may alternatively be a web browser where device 12 is a computer, gaming device or other device supporting full browser capabilities. Client 14 may further be a short message service (SMS) client, or other client supporting mobile devices with less than full browser capabilities. As explained hereinafter, in a further embodiment, client 14 may alternatively and/or additionally support VoIP and other audio protocols.

When IM is the application interface, a connection by a user with bot 10 may be established by the user selecting an identity for bot 10 created and saved in the user's buddy list. Bot 10 may be accessed by a variety of other known connection schemes in alternative embodiments. Bot 10 may alternatively or additionally be configured to initiate contact with a user.

Whether interaction is initiated by the user or the bot, bot 10 may receive content and metadata from the user's IM client. In particular, the content may be textual or voice input from the user. The metadata is information about the user's device, and is used by the bot to customize a format of content the bot presents to the user, as explained in greater detail below.

Bot 10 may include a variety of software or hardware components known in conventional bots for handling content received from a user. In embodiments, bot 10 may be configured to accept and respond using natural language content. A variety of methods are known for providing bots with natural language capabilities. Examples of such methods are disclosed in U.S. Pat. No. 6,754,647, to Tackett, entitled “Method And Apparatus For Hierarchically Decomposed Bot Scripts;” published U.S. Patent Application No. 2003/0182391A1 to Leber et al., entitled “Internet Based Personal Information Manager;” and published U.S. Patent Application No. 2002/0133347A1 to Schoneburg et al., entitled “Method And Apparatus For Natural Language Dialog Interface.” Each of these references is incorporated by reference herein in its entirety. It is understood that a variety of other known natural language schemes may be utilized by bot 10 to interact with a user.

In general, the natural language process of parsing a user's textual phrase and selecting an appropriate response is handled by parser 16, natural language engine 18 and inference engine 20. It is understood that one or more of these modules may be combined together in alternative embodiments.

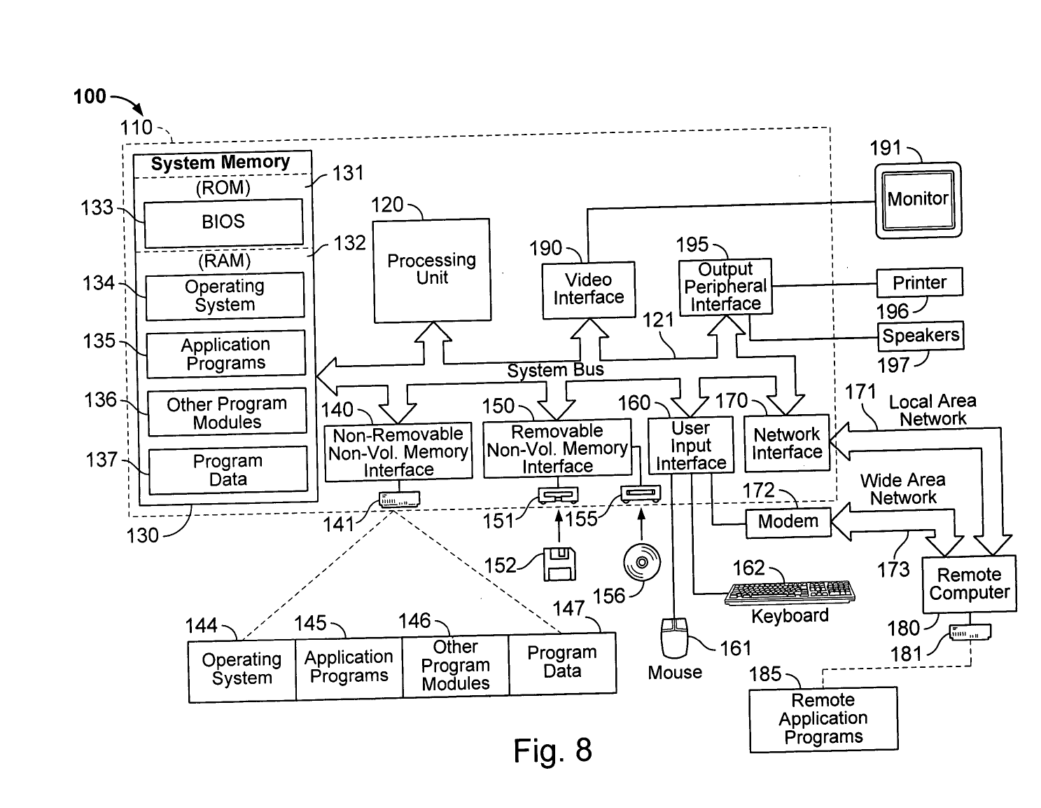

Content received from a user may be received into the device memory such as for example RAM 132 explained hereinafter with respect to FIG. 8. The content can be received in a variety of ways, including input on a keyboard, keypad or, as explained hereinafter, through voice recognition. The content may be natural language, phrases, words, commands, or any sequence of words or symbols reflecting a user's intended statement or response.

Parser 16 prepares the content to be processed by the other modules of the system by removing extraneous information, such as for example unconventional cases and special non-dividable phrases and prefixes. Items such as titles and URL addresses are processed and translated into a form that can be understood by the natural language engine 18 and/or inference engine 20.

The natural language engine 18 and inference engine 20 utilize templates, patterns and other data stored in a knowledge base 22 within a data store 24 (and/or other databases in communication with bot 10) as is known in the art to determine the meaning of the content entered by the user. As indicated, software engines 18 and 20 may be combined into a single engine in embodiments of the system. It is understood that the present system may operate without natural language communication between the user and bot 10. For example, all communication may be menu driven or in accordance with other structured schemes for exchanging content between the bot 10 and the user.

Instead of textual content, the user may convey voice or other audio content over device 12 to bot 10. In such instances, the audio content may be passed to a speech conversion or recognition engine 26 to convert the audio content into a form that can be processed by the inference engine 20. A variety of methods are known for converting audio data into a useable data format. An example of such a system is disclosed in U.S. Pat. No. 6,816,578 to Kredo et al., entitled “Efficient Instant Messaging Using A Telephony Interface,” which patent is incorporated by reference herein in its entirety. It is understood that a variety of other known speech recognition schemes may be utilized by bot 10 to interact with a user providing voice or audio content. While FIG. 1 shows the output of the speech conversion engine being communicated directly to inference engine 20, it is understood that the output of the speech conversion engine may alternatively be supplied to parser 16 or natural language engine 18 in alternative embodiments.

Inference engine 20 determines the substance of the content to be transmitted to the user client. The content passed on by inference engine 20 may be responsive to content received from the user, or the content may be unrelated to a response to user content (such as for example where bot 10 is initiating contact with the user). When responsive to user content, the inference engine may either obtain the appropriate response directly from the knowledge base within store 22, or the inference engine may initiate a search of information received from remote databases via search engine 28.

In particular, there may be instances where inference engine 20 determines that an appropriate response is found from knowledge base 22 within data store 24. Such instances may occur when the user asks for stored personal information relating to the user, the user's stored contacts or for frequently requested information. Alternatively, where the user is engaging bot 10 for conversation or purely social purposes, the appropriate response may be generated by inference engine 20 solely from data stored within knowledge base 22.

However, the inference engine 20 may alternatively determine that the user is requesting information that is not found in knowledge base 22, but instead may be found upon a search of an external database over the World Wide Web. For example, the user may query the bot about current events and news, weather reports, driving directions, movie times, stock quotes, or any conceivable topic that the user believes may be researched over the World Wide Web. In such instances, the inference engine 20 may query the search engine 28 to perform a search for the requested information.

The operation of search engines are well known. However, in general, search engine 28 may be part of a search processing environment 29. Search processing environment 29 may be a crawler-based system having three major elements. First is the spider, also called the crawler 30. The spider visits a number of web pages, such as pages 36a, 36b, 36c, via a network connection to Internet 40, reads the pages, and then follows links to other pages within a particular website. The spider returns to the site on a regular basis to look for changes. The basic algorithm executed by a web crawler takes a list of seed URLs as its input and repeatedly performs the steps of removing a URL from the URL list, determining the IP address of its host name, downloading the corresponding document, and extracting any links contained in it. For each of the extracted links, the crawler 30 translates it to an absolute URL (if necessary), and adds it to the list of URLs to download, provided it has not been encountered before. If desired, the crawler 30 may process the downloaded document in other ways (e.g., index its content).

Everything the spider finds goes into the second part of the search engine, the index 32. The index 32, sometimes called the catalog, is a repository containing a copy of every web page that the spider finds. If a web page changes, then the index is updated with new information. The index 32 may be stored in a data store 34. In embodiments, data store 34 may be separate from data store 24 described above. In embodiments, store 34 and store 24 may be combined into a single data store containing both the knowledge base 22 and index 32.

The third part of the search processing environment 29 is the search engine 28. This is the application program that sifts through the millions of pages recorded in the index to find matches to a search and rank them in order of what it determines to be most relevant. The query generated by the inference engine may be the actual content received from the user, or it may be modified as determined to be necessary by the inference engine. The search engine 28 may return a single result or a list of prioritized results to the inference engine for presentation to the user as explained hereinafter.

In embodiments, the search processing environment 29 may be omitted. In such embodiments, bot 10 may function as a chatterbot, or as a purely social and conversational interface with a user. Additionally, it is understood that one or more the above-described engines and modules may be separated from each other and implemented in any one of the IM client, IM server or third party server.

Once the inference engine has determined the appropriate content, the content is forwarded to the user. However, as indicated in the Background section, different devices have different display functionality. Therefore, embodiments of the present system further employ an endpoint formatting engine 42. As explained above, when user establishes contact with bot 10, metadata is passed from the user device to the bot 10, and in particular to endpoint formatting engine 42. The metadata describes the functionality and characteristics of the user's device, the client running on the device and, in embodiments, may also describe personal preferences and information about the user. The term metadata may be interpreted broadly to cover all data relating the functionality and characteristics of the user's device.

The metadata transmitted with respect to the device functionality and characteristics include, but is not limited to:
client protocol—the set of rules that the device uses when communicating over a network. As one of many examples, IM uses a proprietary protocol referred to as MSN instant messaging protocol 8-13, or MSNP 8-13 (8 being an older version of the protocol and 13 being an updated version of the protocol);
device type and identification—whether the device is a computer, mobile telephone, television, pda, etc.;
device location—the geographical location of the device;
client capabilities—how sophisticated is the software client in use on the device;
device brand—the manufacturer and/or model of the device;
device version—whether the device is an older or newer model of the device.

This information is available to and accessible by bot 10 upon connection to the user device. For example, upon connection to the bot, the client responds with a downlevel (and/or other type) message including the client protocol, client version and client capability. It is also conceivable that information relating to the device (type, identification, brand and/or version) be included in the client protocol message. The bot could perform an IP lookup to determine the device location. The bot can further determine the type of device by the route the information takes to reach the server. For example, if the information is received via a mobile network connection, the bot can determine that the device is a mobile device. It is understood that other metadata relating to device characteristics may be available to and accessible by bot 10 for use by the endpoint formatting engine to customize the content provided by bot 10 to the user device. It is also understood that less than the above-described metadata may be transmitted in embodiments. For example, the endpoint formatting engine may receive only device metadata, only client metadata, only user preference metadata, or only portions of the device, client and/or user preference metadata.

Receipt of the above-described metadata may be used in part or in whole to determine how the content from the inference engine is formatted by the endpoint formatting engine for presentation to the user device. In embodiments, user-defined preferences may also be used to determine content formatting. For example, a user may configure a bot 10 to direct the bot to format all content for a given device in a particular format. This preference information may be stored by the bot, or downloaded to the bot upon connection to the user device.

It is understood that bot 10 may include additional known software engines, modules, routines and/or components in addition to or instead of those described above.

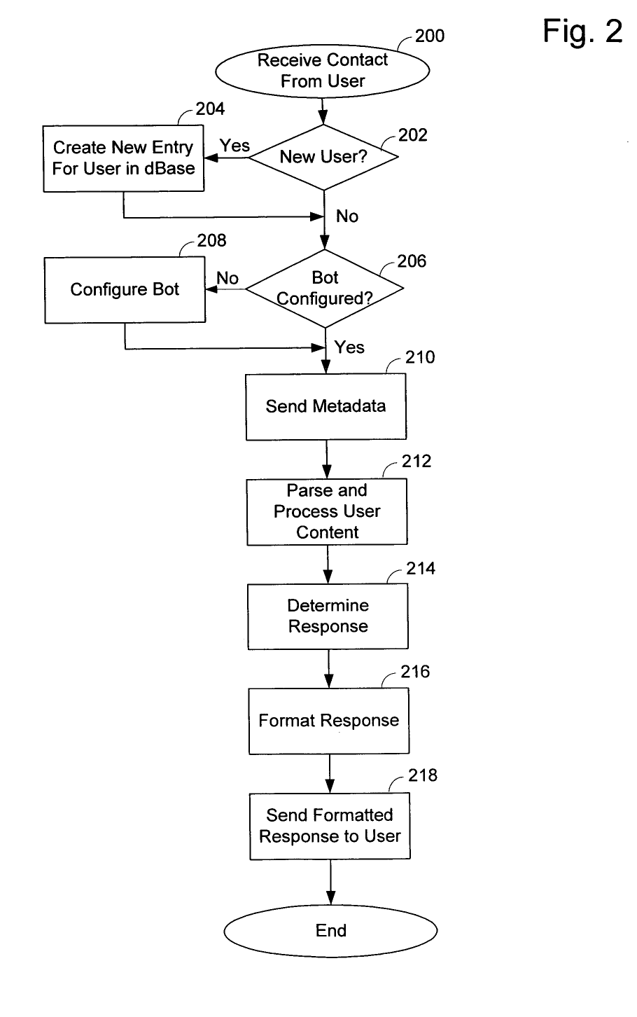

Referring now to FIG. 2, there is shown a flowchart of the steps performed by bot 10 in embodiments of the system. In step 200, the IM server receives contact from a user over computing device 12. In step 202, the IM server determines whether the user is a new or existing user. If new, the user is registered and a new entry for the user is stored in an IM server database in step 204. Once a user identity is confirmed, the IM server determines whether a bot 10 is accessible and configured for the user in step 206. If not, the IM server can guide the user through the bot access, creation and/or configuration in step 208.

Upon a connection between the user and bot 10, the metadata relating to the device, client and/or user is sent to the bot in step 210. The content sent by the user is then parsed and processed as described above (step 212), and the inference engine 20 determines the desired response or content to be sent to the user (step 214). In step 216, the endpoint formatting engine 42 formats the content to optimize its presentation over the interface of device 12, based on the metadata received in step 210. Once the content to be sent to the user is formatted, it is sent to the device 12 in step 218.

This completes a cycle of communication between the user and bot 10. The communications may continue, using the formatting determined in step 216 until the IM session is terminated. The metadata may be stored by the bot in memory accessible to the bot for use in future communications sessions with the user. The metadata could also be cached in a user profile maintained in a database, which keeps a similar user profile for each IM/VoIP user on the network. Alternatively, the metadata may be reacquired in each session.

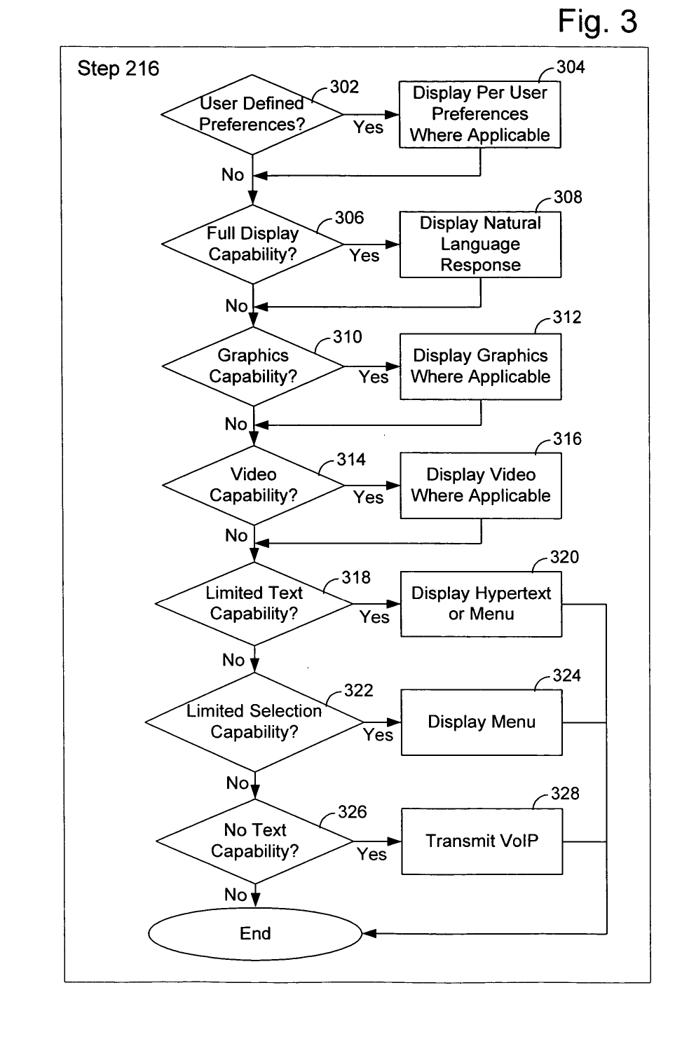

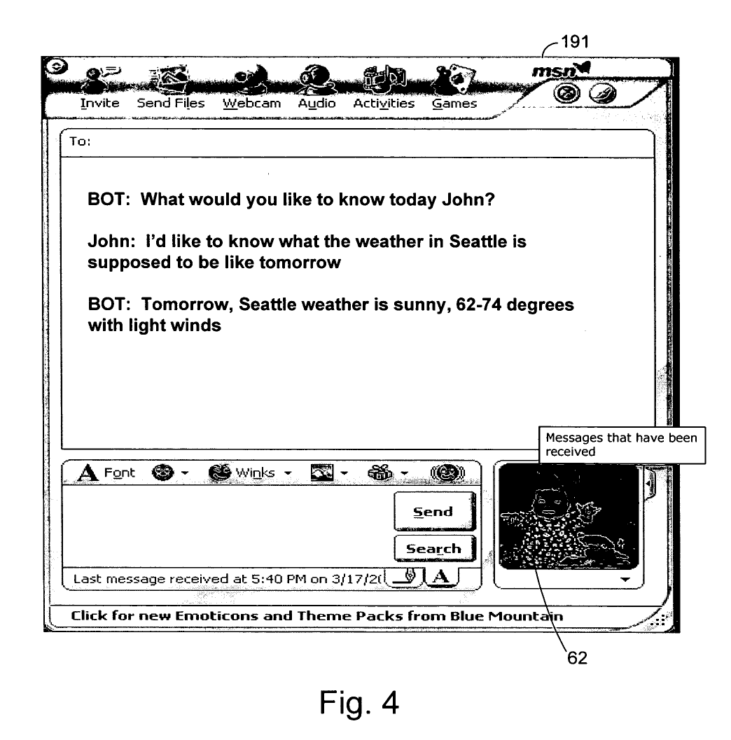

The step 216 of formatting the content is explained in greater detail with respect to the software flowchart of FIG. 3, and the user interface illustrations of FIGS. 4-7. In step 302, the endpoint formatting engine 42 first checks to see if the user has expressed any preferences for the presentation of content that would be applicable to the content to be displayed. If so, the content to be sent by bot 10 is formatted per the user's expressed preferences. In embodiments, the user's preferences for the formatting and display of content may take precedence over any of the formatting that is indicated by the device and client metadata for device 12 (though it need not necessarily be so in alternative embodiments).

In the event there are no expressed user preferences, or in the event the user's preferences do not cover all of the formatting of the content to be sent by bot 10, the endpoint formatting engine 42 may further check whether the device 12 has full display and reply capabilities in step 306. Full display capabilities may for example exist on a desktop or laptop computer running a current or recent version of a browser. There are other examples. In this instance, the endpoint formatting engine 42 may format the content to be sent to device 12 as a natural language response (step 308). An example of this is shown in FIG. 4. As shown, the user and bot 10 are engaging in a natural language conversation displayed on a monitor 191 of device 12. Even where the device has full display capabilities, the endpoint formatting engine 42 may determine that menu or hyperlink format (discussed below) is better if the engine 42 also determines that the device does not have full response capabilities, i.e., the device does not have full keyboard.

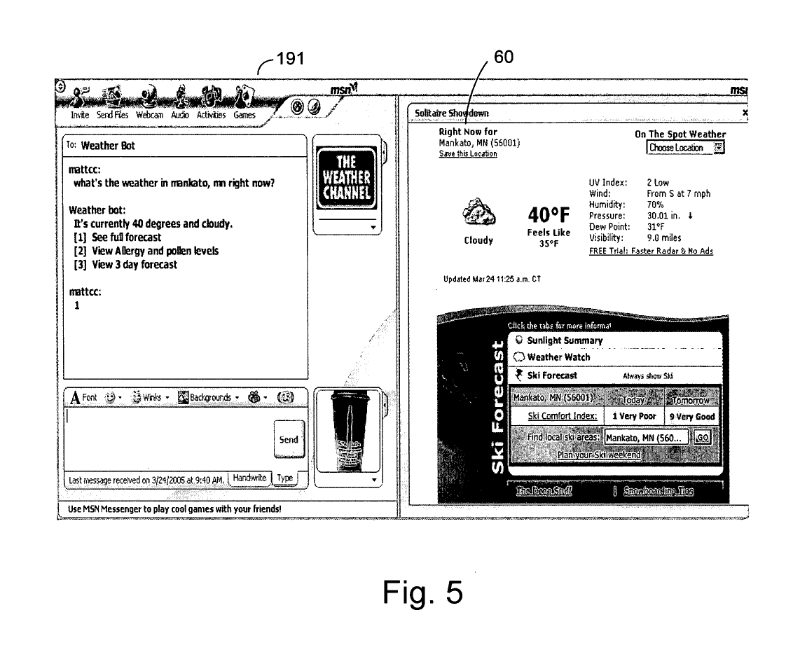

The endpoint formatting engine 42 may also check whether the device 12 has graphics display capabilities in step 310. Again, most desktop or laptop computers running current or recent versions of browsers would have such capabilities. In this instance, the endpoint formatting engine 42 may format the content to be sent to device 12 to include graphics (step 312). Such graphics may be selected by the inference engine 20 as being relevant to the content being sent by the bot 10. The graphics may also be selected as being helpful to the user based on the use's profile and/or the content sent by the user to the bot. For example, FIG. 5 shows an instance where, in response to a query by the user as to the weather in certain location, the bot returned a natural language text display of the requested information to monitor 191, along with a graphic 60 from a website relevant to the user's query. A wide variety of other graphics in response to this and other queries are contemplated. In embodiments, there may also be instances where the endpoint formatting engine 42 detects graphics capabilities, but no graphics are sent with the response from bot 10.

In a further embodiment, where graphics capabilities are detected, the bot 10 may be displayed as a graphical representation 62 on display 191, such as shown in FIG. 4. Graphical representation 60 may be a photograph, avatar or any other image.

The endpoint formatting engine 42 may also check whether the device 12 supports video images in step 314. Many desktop or laptop computers running current or recent versions of browsers would have such capabilities. In this instance, the endpoint formatting engine 42 may format the content to be sent to device 12 to include video images (step 316). Such video clips may be selected by the inference engine 20 as being relevant to the content being sent by the bot 10. The video may also be selected as being helpful to the user based on the use's profile and/or the content sent by the user to the bot. Thus, for example, if the user queries about a television show, a video clip from the show may be downloaded to the user as part of the bot's response. Similarly, where video capabilities are detected, the bot's avatar displayed on monitor 191 may be animated. There may be instances where the endpoint formatting engine 42 detects video capabilities, but no video images are sent with the response from bot 10.

If the endpoint formatting engine 42 determines that the device 12 has limited text capabilities in a step 318, but has the ability to display and select hyperlinks, then the endpoint formatting engine 42 may display the text as a menu or including hyperlinks which may be selected by the user for easy navigation (step 320). Such an embodiment is shown in FIG. 7, where the bot 10 displays a list of hyperlinks 64 leading to additional information about certain stocks over a user's personal digital assistant. It is understood that any of a variety of other information may be formatted and displayed.

In the example illustrated in FIG. 7, the user asked for information about his stocks without having to specify the specific stocks (i.e., “show me information about my stock portfolio”). In this example, the user may have his portfolio stored as part of his personal information on knowledge base 22. Alternatively, the user may have stored the access information to his stock portfolio in his personal information, which access information allows the bot to access the portfolio stored on a third party server accessible via search processing environment 29. In either instance, the inference engine 20 was able to determine what information the user requested, and was able to obtain that information from stored data on knowledge base 22 by itself or in conjunction with search processing environment 29. This information could then be formatted by endpoint formatting engine 42 to optimize the presentation of the information over the user's device 12.

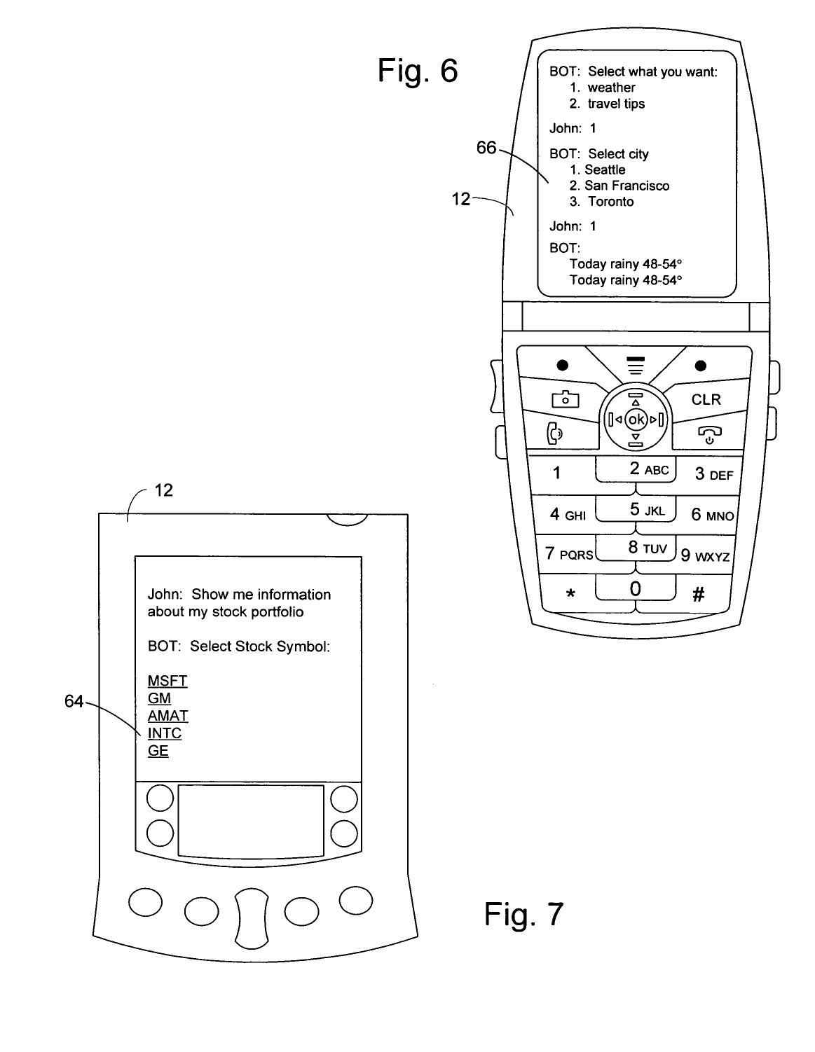

In embodiments where the device 12 does not have the ability to display or select hyperlinks (step 322), or where the selection using hyperlinks may be undesirable, the content to be displayed by bot 10 may instead be displayed as a menu (step 324). Such an embodiment is shown in FIG. 6, where the bot 10 displays content in a menu 66 over a user's mobile telephone.

If the endpoint formatting engine 42 determines that the device 12 has no text capabilities in a step 326, then the endpoint formatting engine 42 may format the content as an audio download to device 12 (step 328). In such an embodiment, the content may be sent from the endpoint formatting engine 42 to a speech conversion engine, which may speech conversion engine 26 described above, or similar software application program for converting data to an audio format. The formatting may result in VoIP or an analog signal (where for example the VoIP/audio call is bridged out onto the PSTN network).

It is understood that the above-described steps may be performed in a different order than that shown in FIG. 3. Moreover, the above-described steps are not intended to be an exhaustive listing of the criteria used by the endpoint formatting engine 42 for formatting the content sent by bot 10 to the user. For example, the endpoint formatting engine may receive additional information relating to the processor speed, memory size and availability, video card capabilities and other properties of the device 12. The properties may also factor into the formatting of the content sent to the device.

Similarly the above-described steps are not intended to be an exhaustive listing of the manner in which the endpoint formatting engine 42 may format the content. It will be understood that any metadata, personal user preferences, or personal user information may be used as a criteria by the endpoint formatting engine 42 for formatting the content, and that a wide variety of other formats may be achieved by the formatting engine 42.

In embodiments described thus far, content sent by a bot to a user is optimized by the endpoint formatting engine 42 in the bot for a particular user's device. In a further embodiment of the present system, the endpoint formatting engine 42 may be utilized for communications between two or more live users. Namely, upon establishing a connection between the two or more users, metadata relating to their respective devices may be sent to the messenger server, and thereafter the content sent to users' respective devices may be optimized by an endpoint formatting engine 42 included on the messenger server (or on the client software on the users' respective devices).

In a further alternative embodiment, an initial connection between two or more live users may occur through a messenger server so that an endpoint formatting engine 42 on the server can detect the respective device parameters and optimize the content format for their devices. This formatting information may be stored, and thereafter, future connections between those users may occur directly peer-to-peer, independently of the messenger server.

As indicated above, while the present system has advantageous use in an application interface such as IM and possibly web and other IM clients, other application interfaces are contemplated. Such additional application interfaces include web searches via a client's web browser, email exchanges via an email server, and bank transactions via automated teller machines.

FIG. 8 illustrates an example of a suitable general computing system environment 100 that may comprise the IM server, device 12 and any processing device shown herein on which the inventive system may be implemented. The computing system environment 100 is only one example of a suitable computing environment and is not intended to suggest any limitation as to the scope of use or functionality of the inventive system. Neither should the computing system environment 100 be interpreted as having any dependency or requirement relating to any one or combination of components illustrated in the exemplary computing system environment 100.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 8, an exemplary system for implementing the inventive system includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 may include a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile discs (DVD) or other optical disc storage, magnetic cassettes, magnetic tape, magnetic disc storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 8 illustrates operating system 134, application programs 135, other program modules 136, and program data 137.

The computer 110 may also include other removable/non-removable, volatile/nonvolatile computer storage media. By way of example only, FIG. 8 illustrates a hard disc drive 141 that reads from or writes to non-removable, nonvolatile magnetic media and a magnetic disc drive 151 that reads from or writes to a removable, nonvolatile magnetic disc 152. Computer 110 may further include an optical media reading device 155 to read and/or write to an optical media 100.

Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disc drive 141 is typically connected to the system bus 121 through a non-removable memory interface such as interface 140, magnetic disc drive 151 and optical media reading device 155 are typically connected to the system bus 121 by a removable memory interface, such as interface 150.

The drives and their associated computer storage media discussed above and illustrated in FIG. 8, provide storage of computer readable instructions, data structures, program modules and other data for the computer 110. In FIG. 8, for example, hard disc drive 141 is illustrated as storing operating system 144, application programs 145, other program modules 146, and program data 147. These components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and a pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 8. The logical connections depicted in FIG. 8 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 8 illustrates remote application programs 185 as residing on memory device 181. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A method of formatting content for presentation to a device over a network connection, comprising the steps of:
(a) determining at least in part the functionality of the device, and
(b) sending content to the device via a bot, the content formatted at least in part based on said step (a) of determining at least in part the functionality of the device.

2. A method as recited in claim 1, said step (a) of determining at least in part the functionality of the device comprising the step of receiving metadata about the device.

3. A method as recited in claim 1, said step (a) of determining at least in part the functionality of the device comprising the step of receiving metadata about at least one of the device and a client application program running on the device.

4. A method as recited in claim 1, said step (a) of determining at least in part the functionality of the device comprising the step of determining the functionality based on at least one of a client protocol of a client running on the device, capabilities of the client, the type of device a location of the device, a brand of the device and version of the device.

5. A method as recited in claim 1, further comprising the step of determining the existence of a user preference for the formatting of content sent to the device, the content sent in said step (b) further formatted based at least in part on the existence of a user preference for the formatting of the content.

6. A method as recited in claim 1, said step (b) comprising the step of presenting the content to the device in a natural language discourse with the user where said step (a) determines the device is a computer capable of displaying natural language phrases and is capable of replying via a keyboard.

7. A method as recited in claim 6, said step (b) comprising the step of presenting the content to the device together with a graphical image where said step (a) determines the device is capable of displaying graphical images.

8. A method as recited in claim 6, said step (b) comprising the step of presenting the content to the device together with a video where said step (a) determines the device is capable of displaying graphical video.

9. A method as recited in claim 1, said step (b) comprising the step of presenting the content to the device in a menu driven format where said step (a) determines the device is a hand-held mobile device.

10. A method as recited in claim 1, said step (b) comprising the step of presenting the content to the device in a hyperlink driven format where said step (a) determines the device is a hand-held mobile device.

11. A method as recited in claim 1, said step (b) comprising the step of presenting the content to the device in an audio format where said step (a) determines the device does not support text.

12. A method of formatting content for presentation to a device over at least one of an instant messaging network connection and a VoIP network connection, comprising the steps of:
(a) receiving information relating to at least one of the device, a client application program running on the device, and a personal preference of a user of the device; and
(b) determining, via a bot, a format of the content to be presented to the device over at least one of the instant messaging network connection and VoIP network connection, the format based at least in part based on said step (a) of receiving information relating to at least one of the device, a client application program running on the device, and a personal preference of a user of the device.

13. A method as recited in claim 12, said steps (a) and (b) being performed by an endpoint formatting engine included as at least part of the bot.

14. A method as recited in claim 12, said step (a) of receiving information relating to at least one of the device, a client application program running on the device, and a personal preference of a user of the device comprising the step of receiving metadata relating to at least one of a client protocol of a client running on the device, capabilities of the client, the type of device a location of the device, a brand of the device and version of the device.

15. A bot capable of formatting content to be sent to a device over a network connection, comprising:
a formatting engine capable of receiving metadata relating to the functionality of the device, and capable of formatting the content to be sent to the device based at least in part on the functionality of the device.

16. A bot as recited in claim 15, the bot forming part of a messenger application interface for supporting instant messaging between the bot and a user of the device.

17. A bot as recited in claim 15, the formatting engine further being capable of presenting the content to the device in a natural language discourse format where the formatting engine determines the device is a computer capable of displaying natural language phrases and is capable of replying via a keyboard.

18. A bot as recited in claim 15, the formatting engine further being capable of presenting the content to the device in one of a menu driven format or a hyperlink driven format where the formatting engine determines the device is a is a hand-held mobile device.

19. A bot as recited in claim 15, the formatting engine further being capable of presenting the content to the device in an audio format where the formatting engine determines the device does not support text.

20. A bot as recited in claim 15, the formatting engine further being capable of receiving information relating to an existence of a personal preference by the user of the device as to how content is to be presented on the device.
